(19) United States
(12) Patent Application Publication
(10) Pub. No.: US 2025/0282425 A1
(43) Pub. Date: Sep. 11, 2025

(54) VEHICLE STRUCTURAL COMPONENT WITH EXTERIOR STIFFENING CHANNELS

(71) Applicant: Shape Corp., Grand Haven, MI (US)

(72) Inventor: Matthew Kuipers, Holland, MI (US)

(73) Assignee: Shape Corp., Grand Haven, MI (US)

(21) Appl. No.: 19/076,734

(22) Filed: Mar. 11, 2025

Related U.S. Application Data
(60) Provisional application No. 63/563,632, filed on Mar. 11, 2024.

(51) Int. Cl. B62D 25/02; B62D 29/00

(52) U.S. Cl. CPC B62D 25/025; B62D 29/008

(57) ABSTRACT

A structural component of a vehicle may include an elongated beam having a seamless outer wall surrounding a hollow interior area along the length of the beam. The outer wall defines a closed-cross-sectional shape along the length of the beam and may be comprised of at least four outer wall sections. The outer wall of the elongated beam may include plurality of channels protruding into the hollow interior area and extending laterally from an inboard side to an outboard side on at least one section of the outer wall of the elongated beam. The outer wall includes a flat surface spanning between each of the plurality of channels. The elongated beam may be comprised of an extruded aluminum, and the channels may be formed after extrusion in an orthogonal direction to the direction of extrusion.

### CROSS-REFERENCE TO RELATED APPLICATION

This application claims the benefit and priority under 35 U.S.C. § 119 (e) of U.S. provisional application Ser. No. 63/563,632, filed on Mar. 11, 2024, the content of which is incorporated herein by reference in its entirety.

### TECHNICAL FIELD

The present disclosure relates to rocker assemblies and more specifically to rocker inserts for vehicle body structures.

### BACKGROUND

Vehicle frames and body structures are designed to support the vehicle and undergo and absorb certain levels of impact forces, such as to prevent distances of inboard intrusion into the vehicle in accordance with various regulatory and legal requirements. For example, side impacts to a vehicle are commonly tested for intrusion ratings with side pole impact testing. The rocker sections of vehicle frames typically interact with side impacts that run longitudinally between the front and rear wheels along the lower outboard portions of a vehicle frame.

It is desirable for the front and side impact forces to be converted into other forms of energy in a predictable and controllable manner. In order to achieve the goals of crashworthiness, light weight, and efficient material usage, improved forms of structural components are desirable. With the incorporation of battery trays in electric and hybrid electric vehicles in the lateral inboard area between opposing rocker sections, it is desirable for the side impact forces to be directed away from the battery tray and towards a vehicle floor cross member. For example, adding a rocker insert within the vehicle rocker assembly can increase its stiffness.

### SUMMARY

The present disclosure provides a structural component of a vehicle, that in some examples, may be a rocker insert or a bumper reinforcement beam. The structural component includes an elongated beam that has a seamless outer wall surrounding a hollow interior area along a length of the elongated beam. The outer wall may define a cross-sectional shape along the length of the elongated beam. The outer wall of the elongated beam may include a plurality of channels that protrude into the hollow interior area and extend laterally in a direction between an inboard side of the elongated beam and an outboard side of the elongated beam, such as on at least one section of the outer wall of the elongated beam.

In some examples, the elongated beam may be comprised of an extruded aluminum. The plurality of channels may be formed in the surface of the elongated beam after extrusion of the beam. The outer wall may include a flat surface spanning between each of the plurality of channels section, such that the section of the outer wall having the channels may be substantially planar. The closed cross-sectional shape may taper at least partially towards the outboard side of the beam. The outer wall of the elongated beam forming the cross-sectional shape may include an upper wall section, a lower wall section, and an inboard wall section extending between the upper wall section and the lower wall section. In some examples, the outer wall also includes an upper angled wall section extending outboard at a downward angle from the upper wall section, a lower angled wall section extending outboard at an upward angled from the lower wall section, and an outboard side wall section extending between the upper angled wall section and the lower angled wall section. Each of the plurality of channels may include a pair of ridges and a furrow. The pair of ridges are located on either side of the furrow where the channel begins to extend inward from the flat surface. The furrow is located at the most inward portion of the channel. The depth of the channel is defined by a length from the ridge to the furrow. The depth of the channel is shorter in length than the length of the flat surface between adjacent channels. In some implementations, the one or more of the plurality of channels may have a U-shape.

According to another aspect of the disclosure, a vehicle rocker assembly may include an inner sill, an outer sill, and a rocker insert comprising a structural beam having at least four wall sections defining a closed cross-sectional shape along the length of the structural beam and a channeled portion located on at least one of the four wall sections. The channeled portion includes a plurality of channels extending laterally along the width of the at least one wall section. In some examples, the structural beam is comprised of extruded aluminum. The structural beam may include a seamless outer wall that comprises the four wall sections. The structural beam may include an inner wall that extends between two of the four wall sections along the length of the structural beam. In some examples, the outer wall includes at least six wall sections that form a tapered cross-sectional shape. The plurality of channels may extend inward into the cross-sectional shape and comprise a U-shape. The plurality of channels may be oriented to extend laterally in parallel alignment with each other and extend laterally between the inner sill and the outer sill. The cross-sectional shape of the rocker insert may include a plurality of passages defined by a plurality of interior walls extending the length of the rocker insert. The structural beam may include an upper wall section, a lower wall section, an outboard side wall section, and an inboard wall section. The channeled portion may extend along the width of the upper and lower wall sections.

According to another aspect of the disclosure, a rocker insert for a vehicle rocker assembly may include an elongated body comprised of an extruded aluminum. The elongated body may have at least four wall sections defining a closed cross-sectional shape. The elongated body may further have a plurality of channels formed into the surface of at least one of the four wall. The plurality of channels may extend in a lateral vehicle direction and orthogonal to an extrusion direction of the elongated body. In some examples, the plurality of channels may be separated by a flat surface of the walls of the elongated body. In some examples, the plurality of channels may extend an entire lateral width of the at least one wall in which the channels are formed.

The details of one or more implementations of the disclosure are set forth in the accompanying drawings and the description below. Other aspects, advantages, purposes, and features will be apparent upon review of the following specification in conjunction with the drawings.

### BRIEF DESCRIPTION OF THE DRAWINGS

FIG. 1 is a side elevation view of a vehicle schematically showing a rocker assembly and a battery tray enclosure.

FIG. 2 is a perspective view of a vehicle schematically showing a rocker assembly and other structural components.

FIG. 3 is an end view of a vehicle rocker assembly including a structural beam configured as a rocker insert.

FIG. 4 is an end view of the structural beam shown in FIG. 3.

FIG. 5 is a perspective view of the structural beam shown in FIG. 4.

FIG. 6 is an enlarged perspective view of the structural beam taken at section VI shown in FIG. 5.

FIG. 7 is an enlarged side view of the structural beam shown taken at section VI shown in FIG. 5.

FIG. 8 is a partial perspective end view of an additional example of a structural beam.

FIG. 9 is a partial perspective end view of another example of a structural beam.

FIG. 10 is a partial perspective end view of yet another example of a structural beam.

FIG. 11 is a perspective view of a further example of a structural beam.

FIG. 12 is an end view of the structural beam shown in FIG. 11.

FIG. 13 is a perspective view of a structural beam configured as a vehicle bumper reinforcement beam.

FIG. 14 is a partial perspective end view of the structural beam shown in FIG. 13.

FIG. 15 shows top views of a vehicle bumper reinforcement beam at stages of undergoing an impact and deforming.

Like reference numerals indicate like parts throughout the drawings.

### DETAILED DESCRIPTION

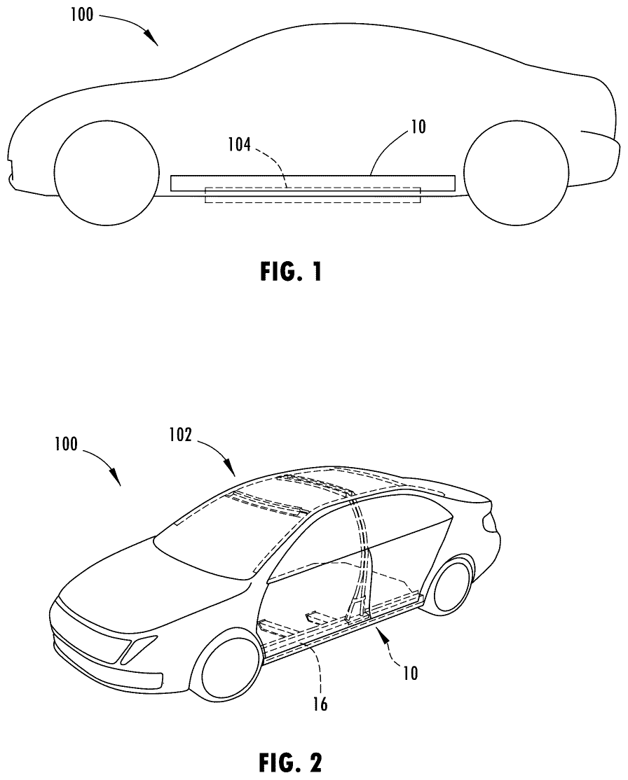

Referring now to the drawings and the illustrative embodiments depicted therein, a structural beam is provided for a vehicle 100, such as for a body structure or frame, as shown in FIGS. 1 and 2. The vehicle frame and associated components may have various designs and configurations, such as for different styles and types of vehicles. As shown for example in FIGS. 1 and 2, the vehicle frame 102 has various structural components, including a B-pillar, a hinge pillar, a floor cross-member, a roof bow, and a header, among other structural components that support the body of the vehicle and protect passengers, engine components, and sensitive electronics from damage when undergoing collisions. In some examples, the vehicle may be operated by a propulsion system that uses a battery, such as a battery or battery modules that may be supported in a battery tray 104 generally located between the axels and below the floor to distribute the battery weight and establish a low center of gravity for the vehicle. The structural beam may be provided in the vehicle frame and/or battery tray for improving resistance to crushing caused by impact forces. For example, the beam may be provided as a rocker assembly and/or as a rocker insert. In other examples, the beam may be provided in a bumper or mid-frame assembly.

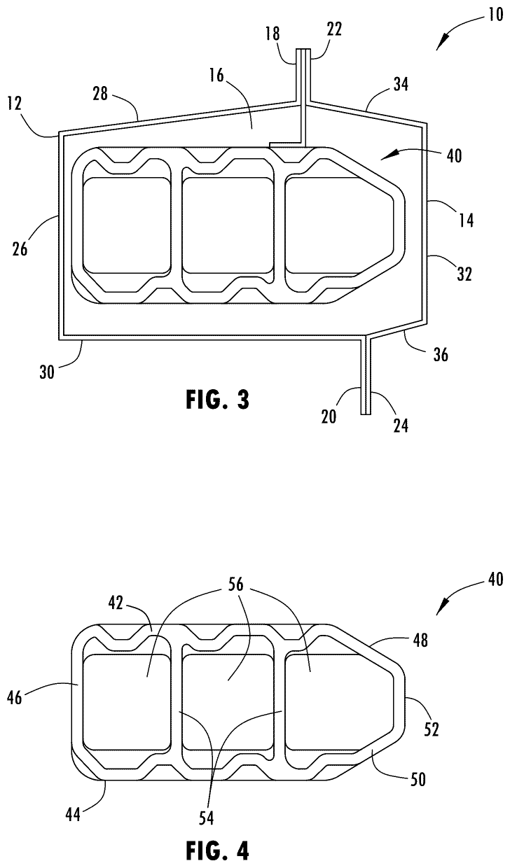

Referring to FIGS. 2 and 3, the structural beam 40 may configured as a rocker insert for a rocker assembly 10. The vehicle rocker components may include a sill panel or panels, such as a sill inner panel 12 and sill outer panel 14 that attach together around an interior area 16, where the terms “inner” and “outer” are made in reference to inboard or inward facing and outboard or outward facing directions on the vehicle. As shown in FIGS. 2 and 3, an exemplary vehicle rocker assembly 10 is provided with a structural beam 40 configured as a reinforcement insert disposed in the interior area 16 to form a multi-tubular rocker structure.

When designing the vehicle rocker assembly with a rocker insert disclosed herein, the outer dimensions of the vehicle rocker assembly may be increased, reduced, or otherwise modified from the example shown herein, such as to meet the required impact and loading conditions. The rocker insert may span a partial section of the vehicle rocker assembly or the entire length of the rocker assembly, such as to extend beyond the rocker assembly into and to also reinforce an adjacent component. The rocker insert disclosed herein may comprise the entire vehicle component or may be joined to additional reinforcements or parts of the vehicle component, such as at desired sections of the vehicle component. Further, in some examples the rocker assembly may be embodied as a subassembly or as part of a corresponding vehicle component, such as a structural component or a battery tray component and as such may be designed to undergo various impact forces and to support and sustain different loading conditions.

Unless specified to the contrary, it is generally understood that additional implementations of the structural beam may have an opposite orientation from the examples shown and described, such as where the sill panels identified as an inner panel may be used as the outer panel and the sill panels identified as an outer panel may be used as the inner panel. The cross-sectional shape of the inner and outer panels may vary along the rocker, such as, for example, by flaring outward at the ends.

Referring now to the vehicle rocker assembly 10 shown in FIG. 3, a first sill panel 12 and a second sill panel 14 are attached together to surround a hollow interior space 16 between the sill panels 12, 14. The vehicle rocker assembly 10 shown in FIG. 3 is embodied as a vehicle rocker component. Accordingly, the first sill panel 12 may be referred to as a sill inner panel of a rocker component. The first sill panel 12 has an upper flange 18 and a lower flange 20 that extend along respective upper and lower edges of the inner panel. The first sill panel 12 protrudes inboard from the upper and lower flanges 18, 20 to form outward facing concave structures. The second sill panel 14, which may be referred to as a sill outer panel of a rocker component, has a C-shaped cross section with flanges 22, 24, which may similarly be referred to as an upper flange 22 and a lower flange 24. The upper flanges 18, 22 and the lower flanges 20, 24 of the inner and outer sill panels 12, 14 are attached together, such as via welding, with the concave structures facing each other. The upper and lower flanges 18, 20, 22, 24 of each of the sill panels 12, 14 as shown in FIG. 3 extend longitudinally, continuously along the edges of the rocker component; however, it is contemplated that the flanges may be trimmed away in select areas to facilitate frame attachment or to reduce weight.

As further shown in FIG. 3, the inner and outer sill panels 12, 14 are joined together to define a hollow interior space 16 between the sill panels 12, 14. The upper and lower flanges 18, 20, 22, 24 are substantially planar and oriented in a generally vertical configuration, such as to mate in generally continuous contact along the length of the component. The upper and lower flanges 18, 20, 22, 24 may be joined together via welding, and preferably spot welding, although it is conceivable that alternative welding methods or joining means may be used in addition or in the alternative to spot welding in different implementations of a rocker component, such as adhesive or fasteners or the like.

In some examples, the first sill panel 12, or inner panel of the vehicle rocker assembly 10, has an inner wall 26 that is substantially planar. The inner wall 26 integrally interconnects with a corner transition to an upper wall 28 and a lower wall 30 at the respective upper and lower ends. The corner transitions are approximately 90 degrees between the inner wall 26 and the upper and lower walls 28, 30. Also, the corner transitions are defined by the longitudinal bends to a sheet material that forms the first sill panel 12, such as a metal sheet (e.g., an advanced high strength steel sheet or aluminum sheet). Similarly, the upper and lower walls 28, 30 each have a corner transition of approximately 90 degrees to the upper flange 18 and the lower flange 20, respectively. The corner transitions are also defined by longitudinal bends in the sheet material of the first sill panel 12, such as formed by a roll form process. As also shown in FIG. 3, the upper and lower flanges 18, 20 are substantially planar and oriented in parallel alignment with the planar extent of the inner wall 26. The upper and lower walls 28, 30 of the first sill panel 12 are also substantially planar and, as shown in FIG. 3, are substantially parallel to each other, although in additional examples they may be slightly angled from each other. The corner transitions may also have an angular transition greater or less than shown in FIG. 3, such as approximately between 40 and 120 degrees, between 70 and 100 degrees, between 80 and 95 degrees, or between 82 and 92 degrees.

As also shown in FIG. 3, the second sill panel 14 or outer panel of the vehicle rocker assembly 10 has an outer wall 32 that is substantially planar and integrally interconnects with an upper wall 34 and a lower wall 36 at its respective upper and lower ends. The corner transitions of approximately 80 degrees between the outer wall 32 and the upper and lower walls 34, 36 are defined by longitudinal bends to a sheet material that forms the second sill panel 14. The sheet material may be the same or different from the first sill panel 12 and may include a metal sheet, such as an advanced high strength steel sheet or aluminum sheet. Similarly, the upper wall 34 also has a corner transition to the upper flange 22 and the lower wall 36 has a corner transition to the lower flange 24, which are each also defined by longitudinal bends in the sheet material of the second sill panel 14. Again, the corner transitions between the upper and lower walls 34, 36 and the upper and lower flanges 22, 24 and the outer wall 32 may have an angular transition greater or less than shown in FIG. 4, such as approximately between 40 and 120 degrees, between 70 and 100 degrees, between 80 and 95 degrees, or between 82 and 92 degrees.

As shown in FIG. 3, the upper and lower flanges 22, 24 are substantially planar and oriented in parallel alignment with the planar extent of the outer wall 32. The upper and lower walls 34, 36 of the second sill panel 14 are also substantially planar, but are slightly angled from being orthogonal to the outer wall 32 and flanges 22, 24. With the flanges 18, 20, 22, 24 of the panels 12, 14 attached together, the walls thereof define a substantially hexagonal cross-sectional shape; however, it is appreciated that additional examples of the rocker insert may have various alternative cross-sectional shapes (e.g., a substantially rectangular shape) and different wall configurations for the corresponding vehicle design (e.g., portions of the inner or outer walls that are not vertically oriented). It is also contemplated that in other examples the outer sill and the inner sill may each include a different configuration including but not limited to the outer sill having an inward or outward protruding stiffening rib portion configured to provide additional stiffness and side impact support.

As further shown in FIGS. 3, the vehicle rocker assembly 10 includes the structural beam 40 configured as a rocker insert disposed within the elongated hollow interior 16 of the rocker assembly 10. The structural beam 40 is further illustrated in FIGS. 4-7. As shown in the cross-section of the structural beam 40 in FIG. 4, the beam 40 has a seamless outer wall surrounding the hollow interior area 16 along the beam. The elongated beam is thereby considered seamless, such that the beam 40 is formed without a weld seam, for example, through an extrusion process. The outer wall defines a closed cross-sectional shape, which extends along the length of the beam 40. The outer wall of the structural beam 40 includes at least four outer wall sections. As shown in FIG. 4, the beam 40 may include an upper wall section 42, a lower wall section 44, and at least two side wall sections 46 extending between the upper wall section 42 and the lower wall section 44. As such, the beam 40 may include at least six wall sections, such as illustrated in FIG. 4, where the closed cross-sectional shape tapers at least partially towards the outboard side. The beam 40 includes an inboard side wall section 46 extending from the upper wall section 42 to the lower wall section 44 on an inboard facing side of the rocker and/or vehicle. The outboard facing side of the beam 40 is configured with an outboard tapered end, having an upper angled wall section 48 extending at a downward angle from the upper wall section 42, a lower angled wall section 52 extending at an upward angle from the lower wall section 44, and an outboard side wall section 50 extending between the upper angled wall section 48 and the lower angled wall section 52. The outboard side wall section 50 has a length shorter than the inboard side wall section 46. In additional examples, the outboard facing side of the beam may be the same configuration as the inboard facing side, such that the outboard facing side includes a side wall section having the same length as the inboard side wall section. The beam 40 may be supported and suspended in the hollow interior 16 of the rocker assembly 10, as shown in FIG. 3, with at least one hand-off bracket that is secured between the sills. In other examples, the wall sections of the insert beam may by coupled to the inner wall 26 of the first sill 12 and/or the outer wall 32 of the second sill 14 to support the beam in the elongated hollow interior 16 of the rocker assembly 10.

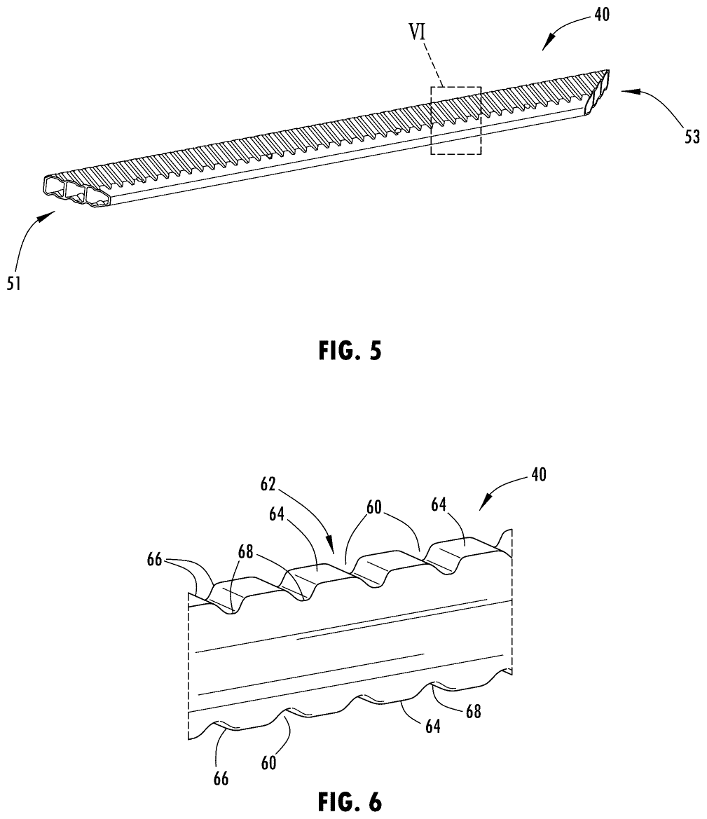

In some examples, the at least four exterior wall sections of the structural beam 40 define an elongated body or a tubular body having a closed cross-sectional shape along the length of the elongated beam. The cross-sectional shape may extend generally along the length of the beam 40 from a front end 51 to a rear end 53 (FIG. 5). The beam 40 may include an inner or interior wall 54 or a plurality of interior walls that extend between two of the four wall sections along the length of the beam 40, such that the cross-sectional shape includes a plurality of hollow passages defined by the interior wall 54. As shown in FIGS. 3 and 4, the beam 40 includes two interior walls 54 extending between the upper wall section 42 and the lower wall section 44 of the beam 40, defining three passages 56 which extend the length of the beam 40. Alternatively, the cross-sectional shape may have more or less passages.

The beam 40, such as shown in FIGS. 5-7, includes a channeled portion 62 in at least one of the exterior wall sections, where the channeled portion 62 may provide a plurality of channels 60 that protrude into the hollow interior area 16. The wall section of the beam 40 that has the channels 60 is substantially planar. In some examples, the beam 40 may include a channeled portion 62 in the upper wall section 42 and/or the lower wall section 44. As shown in FIGS. 3-7, the channels 60 are disposed on both the upper wall section 42 and the lower wall section 44 of the beam 40. In other examples, the channels 60 may be disposed on the upper wall section 42 or the lower wall section 44. Also, as shown in FIG. 5, the channels 60 are disposed on the upper and lower wall sections 42, 44 along the entire length of the beam 40. In other examples, the channels 60 may be disposed on the upper 42 and/or lower wall section 44 in only a portion of the length of the beam 40. It is also contemplated in other examples that the channels may be disposed on other surfaces of the structural beam, including the upper angled wall section, lower angled wall section, or the side wall sections of the beam.

As shown in FIGS. 5-7, the channeled portion 62 includes alternating channels 60 and flat surfaces 64. The channels 60 and flat surfaces 64 are oriented to extend in a lateral vehicle direction, generally extending across the width dimension of the vehicle. For example, the channels 60 are configured to be oriented to generally align with anticipated lateral impacts to the side of the vehicle to provide increased stiffness to the corresponding portion of the upper 42 and/or lower wall sections 44 of the beam 40. Moreover, the channels 60 extend along the planar extent of respective wall, such as the upper wall section 42 and/or the lower wall section 44. In other examples, the channels may be disposed on other surfaces of the beam, such that the channels may extend along the respective surface upon which the channels are disposed. As also shown in FIGS. 5-7, the channels 60 are in parallel alignment with each other and extend laterally between the inner sill 12 and the outer sill 14.

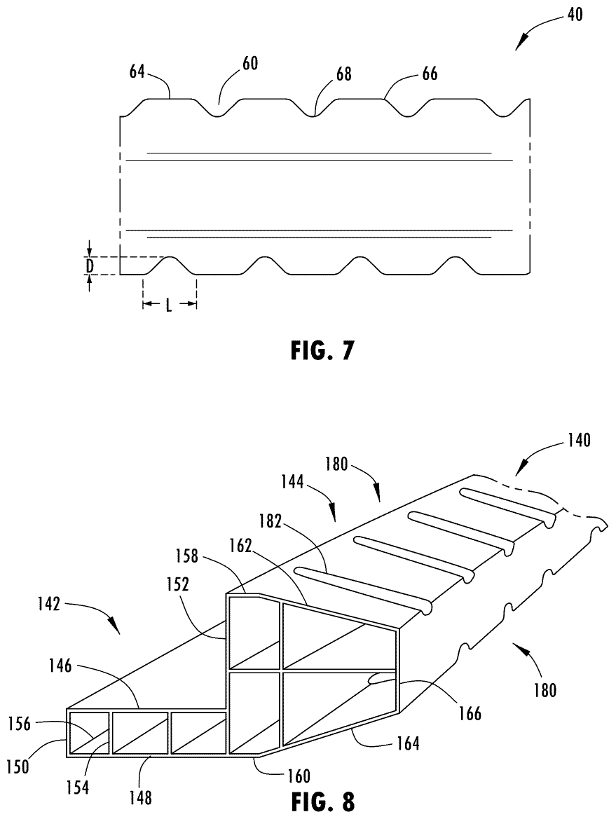

In some examples, the channels 60 extend inward into the cross-sectional shape with a generally rounded U-shape. For example, each channel 60 may include a pair of ridges 66 located at the initial area of inward deformation to the beam 40, which circumscribes the periphery of the channel 60 on either side. Each channel 60 also may include a furrow 68 located at the most inward point, generally at the greatest degree of inward deformation. As shown in FIG. 7, the channels 60 have a depth D from the ridge 66 to the furrow 68, which is consistent throughout the length of the channel 60. In other examples, such as shown in FIG. 10, the depth D may reduce towards the ends of the channel, for example toward either of the side walls.

As also shown in FIG. 7, the flat surfaces 64 have a length L spanning between ridges 66 of adjacent channels 60. The length L of the flat surfaces 64, such as shown in FIG. 7, may be equal throughout the length of the beam 40. Likewise, in other examples, the length L may be shorter or longer at portions of the beam 40 to have a desired change in stiffness at desired locations. For example, in some examples, the length L may be shorter in some portions of the beam 40, resulting in a higher concentration of channels 60 and thus increased stiffness in said portions. In other examples, the length L may be longer in some portions, resulting in a lesser concentration of channels and thus a decreased stiffness in said portions. In some examples, the length L of the flat surfaces 64 may be longer than the depth D of the channels. In other examples, the length L may be equal to or less than the depth D of the channels.

The structural beam may be comprised of any metal or metal alloys that have the desired characteristics, such as stiffness, tensile strength, and the like. For example, it is contemplated that the structural beam disclosed herein may be formed from extruded metal alloy, such as an aluminum alloy, thus providing a seamless beam such that the beam is without welds or attachment seams in the material. In other examples, the beam may be made of a sheet material, such as a high strength or ultra-high strength steel. Once the beam is formed from the extruded metal alloy, the channels are formed orthogonal to the direction of extrusion. In some examples, the channels 60 may be roll-formed after extrusion and prior to quenching while the beam is still at an elevated temperature. In other examples, the channels may be formed after quenching when the beam has returned to a generally ambient temperature.

Referring to FIGS. 8-12, it should be understood that the structural beam 40 disclosed herein may be designed with various cross-sectional geometries configured for particular uses and vehicle components. In an example as illustrated in FIG. 8, the structural beam 140 is similar to the structural beam as described above with respect to the example shown in FIGS. 4-7. However, as shown in FIG. 8, the beam has a different cross-sectional shape which may, for example, be used as a lateral support for a battery tray. The structural beam 140 includes an inboard portion 142 and an outboard portion 144. The inboard portion 142 comprises a rectangular cross-section defined by a first upper wall section 146, a first lower wall section 148, an inboard side wall section 150, and a common wall section 152. The inboard side wall section 150 extends from the first upper wall section 146 to the first lower wall section 148 on an inboard facing side of the inboard portion 142. The common wall section 152 extends from the first upper wall section 146 to the first lower wall section 148 on an outboard facing side of the inboard portion 142. In some examples, the inboard portion 142 may include interior wall sections 154 which extend from the first upper wall section 146 to the first lower wall section 148 and extend the length of the inboard portion 142, defining passages 156 throughout the cross-section of the inboard portion 142.

As also shown in FIG. 8, the outboard portion 144 comprises a tapered cross-section defined by the common wall section 152, a second upper wall section 158, a second lower wall section 160, an upper angled wall section 162, a lower angled wall section 164, and an outboard side wall section 166. The second lower wall section 160 may be in the same horizontal plane as the first lower wall section 148. The common wall section 152 extends upward beyond the first upper wall section 146 such that the outboard portion 142 has a vertical height greater than the inboard portion 144. The second upper wall section 158 extends outboard from the top of the common wall section 152. The upper angled wall section 162 extends in an outboard direction at a downward angle from the second upper wall section 158, the lower angled wall section 164 extends in an outboard direction at an upward angled from the second lower wall section 160, and the outboard side wall section 166 extends vertically between the upper angled wall section 162 and the lower angled wall section 164. The outboard portion 144 may also include interior wall sections 154 which define passages 156 throughout the length of the cross-section of the outboard portion 144.

As further shown in FIG. 8, at least one surface of the beam 140 may include a channeled portion 180. The beam illustrated in FIG. 8 includes a channeled portion 180 on the upper angled wall section 162 and the lower angled wall section 164. The channels 182 extend along the entire width each of the upper angled wall section 162 and the lower angled wall section 164. In other examples, channels may be disposed on any of the other surfaces of the beam to provide increased stiffness to the surfaces as desired.

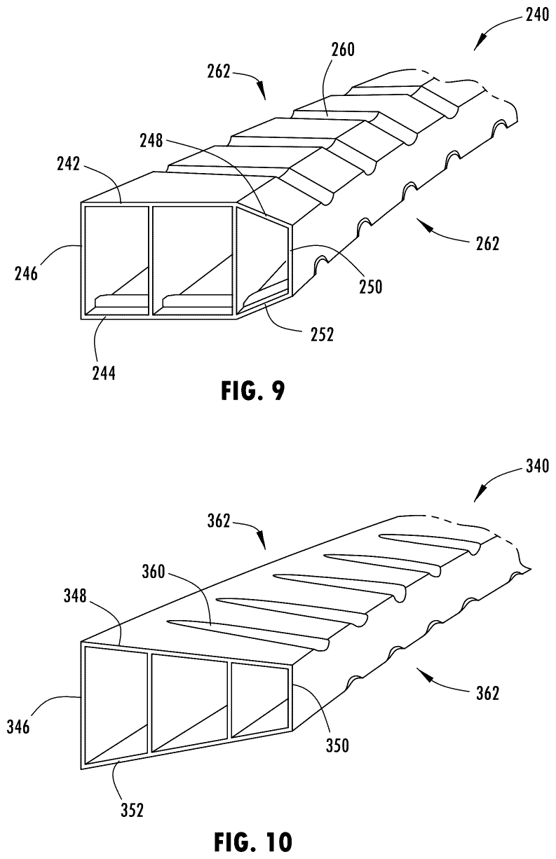

Referring to FIG. 9, the structural beam 240 shown is similar to the structural beam as described above with respect to the example shown in FIGS. 4-7. In the illustrated example, the beam 240 includes a channeled portion 262 which extends the width of an upper wall section 242 and an upper angled wall section 248. Also, a channeled portion 262 extends the width of a lower wall section 244 and a lower angled wall section 252. The channeled portion 262 that extend along the upper wall section 242 and the upper angled wall section 248 includes channels 260 which are aligned such that each channel 260 extends horizontally across the width of both the upper wall section 242 and the upper angled wall section 248. Similarly, each channel 260 which extends along the lower wall section 244 and the lower angled wall section 252 are horizontally aligned to extend along the width of both the lower wall section 244 and the lower angled wall section 252.

Referring to FIG. 10, the structural beam 340 shown is similar to the structural beam as described above with respect to the example shown in FIGS. 4-7. In the illustrated example, the beam does not include a generally horizontal upper wall section or lower wall section. Instead, the exemplary structural beam 340 includes an upper angled wall section 348 which extends from an inboard side wall section 346 to an outboard side wall section 350, and a lower angled wall section 352 which extends from the inboard side wall section 346 to the outboard side wall section 350. In some examples and as illustrated, the channels 360 may extend along a portion of the width of the upper angled wall section 348 and the lower angled wall section 352. The channels 360 have a depth that reduces from the outboard side wall section 350 toward the inboard side wall section 346, where the channels 360 terminate before reaching the inboard side wall section 346.

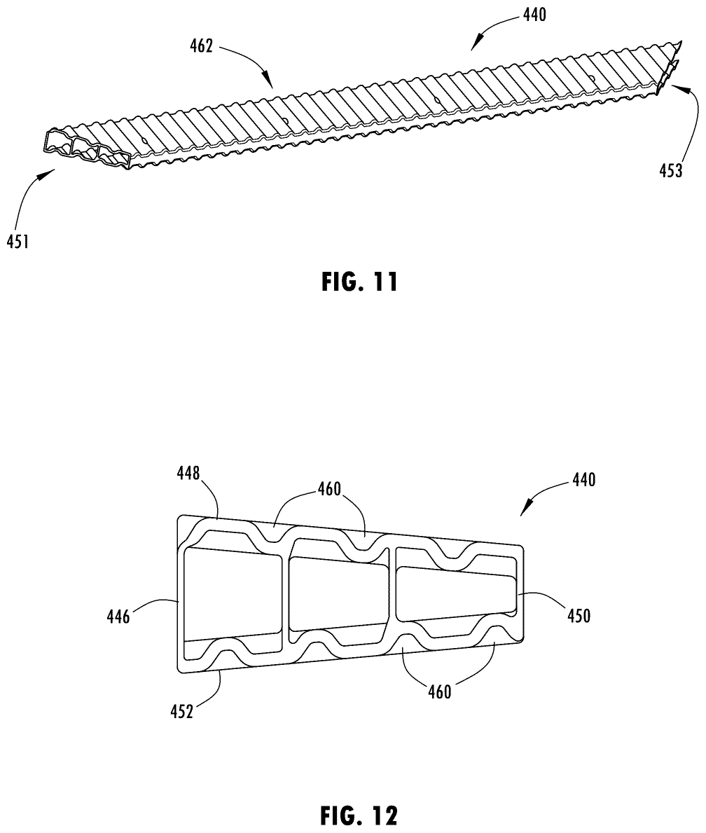

Referring to FIGS. 11 and 12, a structural beam 440 is provided similar to the structural beam as described above with respect to the example shown in FIGS. 4-7 with a different cross-sectional shape. As shown, the structural beam 440 has a tapered cross-sectional shape, narrowing towards an outboard side of the beam 440. The structural beam 440 includes an upper angled wall section 448 which extends from an inboard side wall section 446 to an outboard side wall section 450, and a lower angled wall section 452 which extends from the lower extends from the inboard side wall section 446 to the outboard side wall section 450. In the provided example, a plurality of channels 460 extend along the entire width of the upper angled wall section 448 and the lower angled wall section 452, such that the channels 460 span from the inboard wall section 446 to the outboard wall section 450. In this example, the channeled portion 460 is provided along the length of the beam 440 from the front end 451 to the rear end 453.

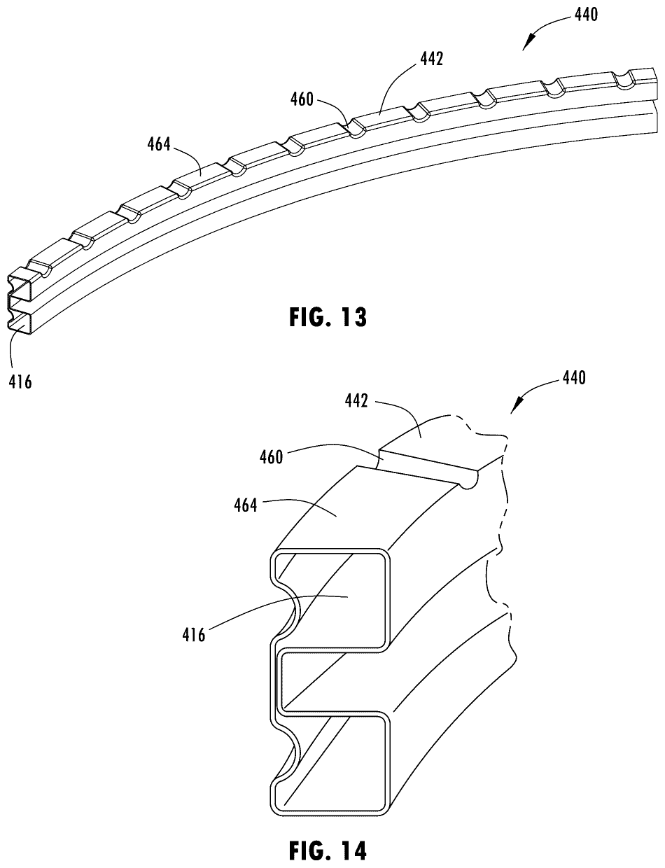

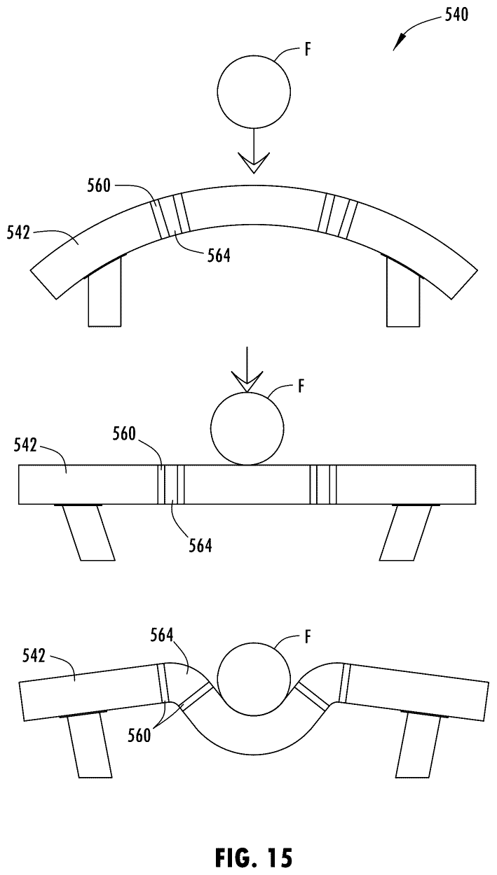

Referring to FIGS. 13-15, a structural beam 540 is shown that may be configured as a bumper reinforcement beam. The bumper 540 is an elongated beam having a seamless outer wall surrounding an interior area 516 and defining a closed cross-sectional shape. A plurality of channels 560 protrude into the interior area 516 from an upper wall surface 542 of the outer wall. The upper wall surface includes a plurality of flat surfaces 564 spanning between adjacent channels 560. In other examples, channels may be provided on other outer wall surfaces. In some examples as illustrated in FIG. 13, the channels 560 may be provided along the entire length of the beam 540, providing a global stiffness to the length of the beam. In other examples as illustrated in FIG. 15, the channels 560 may be provided in localized areas along the length of the beam 540, providing specific areas of increased stiffness along the beam. Localized areas of stiffness provided by the channels may provide areas for desired deformation of the bumper to occur under impact forces F, such as to initiate bending at or near the channels 560.

It is contemplated that the internal reinforcements of the disclosed vehicle rocker assembly may be incorporated in other types of structural beams, such as in frames and structures of automotive and marine vehicles, buildings, storage tanks, furniture, and the like. With respect to vehicle applications, the vehicle component disclosed herein may be incorporated with various applications of different structural components. The vehicle component may be designed to support and sustain different loading conditions, such as for supporting certain horizontal spans or axial loading conditions. Also, the vehicle component may be designed to undergo various impact forces, such as for the illustrated rocker assemblies, pillar structures, and the like. The cross-sectional geometry, material type selections, and material thickness within the cross-sectional profile of the vehicle component may be configured for such a particular use and the desired loading and performance characteristics, such as the weight, load capacity the beam, force deflection performance, and impact performance of the vehicle component.

For purposes of this disclosure, the articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. Furthermore, the terms “first,” “second,” and the like, as used herein do not denote any order, quantity, or importance, but rather are used to denote element from another.

Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. For example, the terms “approximately,” “about,” and “substantially” may refer to an amount that is within less than 5% of, within less than 1% of, within less than 0.1% of, and within less than 0.01% of a stated amount.

Further, it should be understood that any directions or reference frames in the preceding description are merely relative directions or movements. For example, the terms “upper,” “lower,” “right,” “left,” “rear,” “front,” “vertical,” “horizontal,” “inboard,” “outboard” and derivatives thereof shall relate to the orientation shown in FIG. 1. However, it is to be understood that various alternative orientations may be provided, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A structural component of a vehicle, the structural component comprising:
an elongated beam having a seamless outer wall surrounding a hollow interior area along a length of the elongated beam, the outer wall defining a closed cross-sectional shape along the length of the elongated beam,
wherein the outer wall of the elongated beam includes a plurality of channels that protrude into the hollow interior area and extend laterally in a direction between an inboard side and an outboard side of the elongated beam.

2. The structural component of claim 1, wherein the elongated beam is comprised of an extruded aluminum.

3. The structural component of claim 2, wherein the plurality of channels are formed in at least one surface of the elongated beam after extrusion.

4. The structural component of claim 1, wherein the plurality of channels extend across at least one section of the outer wall, and the outer wall includes a flat surface spanning between each of the plurality of channels.

5. The structural component of claim 1, wherein the closed cross-sectional shape tapers at least partially towards the outboard side.

6. The structural component of claim 5, wherein the outer wall of the elongated beam includes an upper wall section, a lower wall section, an inboard side wall section extending between the upper wall section and the lower wall section, an upper angled wall section extending outboard at a downward angle from the upper wall section, a lower angled wall section extending outboard at an upward angle from the lower wall section, and an outboard side wall section extending between the upper angled wall section and the lower angled wall section.

7. The structural component of claim 1, wherein each of the plurality of channels includes a pair of ridges and a furrow, the pair of ridges located on either side of the furrow, and where the channel begins to extend inward from the flat surface.

8. The structural component of claim 7, wherein the furrow is located at the most inward portion of the channel.

9. The structural component of claim 8, wherein a depth of the channel is defined by a length from the ridge to the furrow, and wherein the depth of the channel is shorter in length than a length of the flat surface between adjacent channels.

10. The structural component of claim 1, wherein the plurality of channels have a U-shape.

11. A vehicle rocker assembly, comprising:
an inner sill;
an outer sill; and
a rocker insert comprising a structural beam comprising at least four wall sections defining a closed cross-sectional shape along a length of the structural beam and a channeled portion located on at least one of the four wall sections,
wherein the channeled portion includes a plurality of channels extending laterally over the width of the at least one wall section.

12. The vehicle rocker assembly of claim 11, wherein the structural beam is comprised of extruded aluminum.

13. The vehicle rocker assembly of claim 11, wherein the structural beam includes a seamless outer wall that comprises the four wall sections.

14. The vehicle rocker assembly of claim 13, wherein the structural beam includes an inner wall that extends between two of the four wall sections along the length of the structural beam.

15. The vehicle rocker assembly of claim 13, wherein the outer wall includes six wall sections that form a tapered cross-sectional shape.

16. The vehicle rocker assembly of claim 11, wherein the plurality of channels extend inward into the cross-sectional shape and comprise a U-shape.

17. The vehicle rocker assembly of claim 11, wherein the plurality of channels are oriented to extend linearly and in parallel alignment with each other and to extend laterally between the inner sill and the outer sill.

18. The vehicle rocker assembly of claim 11, wherein the cross-sectional shape of the rocker insert includes a plurality of passages defined by a plurality of interior walls extending the length of the rocker insert.

19. The vehicle rocker assembly of claim 11, wherein the structural beam includes an upper wall section, a lower wall section, an outboard side wall section, and an inboard side wall section, and wherein the channeled portion extends along the width of both the upper wall section and the lower wall section.
